(19) United States
(12) Patent Application Publication
(10) Pub. No.: US 2017/0220585 A1
(43) Pub. Date: Aug. 3, 2017

(54) SENTENCE SET EXTRACTION SYSTEM, METHOD, AND PROGRAM

(71) Applicant: NEC Corporation, Tokyo (JP)

(72) Inventors: Kosuke YAMAMOTO, Tokyo (JP); Takashi ONISHI, Tokyo (JP); Masaaki TSUCHIDA, Tokyo (JP); Hironori MIZUGUCHI, Tokyo (JP)

(21) Appl. No.: 15/328,199

(22) PCT Filed: Jul. 21, 2015
(86) PCT No.: PCT/JP2015/003652

§ 371 Date: Jan. 23, 2017

(30) Foreign Application Priority Data
Jul. 23, 2014 (JP) 2014-149425

(51) Int. Cl. G06F 17/30

(52) U.S. Cl. CPC G06F 17/3071

(57) ABSTRACT

A similar sentence set generation unit 81 groups sentences representing a same concept or event from a set of analysis target sentences, to generate a similar sentence set. A similar sentence set extraction unit 82 extracts, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

### TECHNICAL FIELD

The present invention relates to a sentence set extraction system, sentence set extraction method, and sentence set extraction program for extracting a set into which sentences to be analyzed are classified.

### BACKGROUND ART

Text mining is a data analysis technique that, from text data written in a natural language as input, determines the overall tendency of the contents and discovers useful knowledge. By using text mining, for example, the contents of inquiries can be determined from response notes in a call center.

For example, Patent Literature (PTL) 1 describes a text mining system for displaying an inter-word modification relation network structure by focusing on the relations of three or more words. The text mining system described in PTL 1 analyzes language information included in a large amount of text data, extracts relations of words and modification relations, and visualizes and displays text mining results of these relations.

PTL 2 describes a method of determining inter-text synonymous or entailment relations and performing clustering on text having the same meaning to thus summarize the contents of text in directly understandable form.

### CITATION LIST

### Patent Literature

PTL 1: Japanese Patent Application Laid-Open No. 2007-293685

PTL 2: International Patent Application Publication No. 2013/161850

### SUMMARY OF INVENTION

### Technical Problem

To extract text indicating specific contents from a large amount of text data, it is more efficient to use an extractor for extracting the contents rather than using the system described in PTL 1. Such an extractor can be realized by constructing an extraction rule or an extraction learning model beforehand.

For example, consider the case of extracting a specific demand or claim from inquiries at a call center. In this case, for example, desired text can be efficiently extracted from a large amount of text data by using an extractor for extracting text classified into the contents “fee is high” or the contents “usability is poor”.

However, text extractable by such an extractor is limited to text indicating the contents of classification expected beforehand. Since it is difficult to prepare an extractor for contents that cannot be expected beforehand, text of contents that cannot be expected is overlooked.

For example, in the case of using the aforementioned extractor, it is possible to extract text indicating the contents such as “fee is high” or the contents “usability is poor” from text data indicating inquiries at a call center. However, even when text indicating the contents “other company is better” is included in the text data, the text is overlooked if there is no extractor for extracting such contents.

FIG. 12 is an explanatory diagram depicting an example of a typical method of extracting specific opinions. FIG. 12 depicts a case example of a call center. For example, suppose claims or demands are classified and extracted from inquiries at the call center. The underlined sentences in FIG. 12 represent claims or demands

Suppose there are two types of extractors “complaint about fee” and “complaint about service”, as depicted in FIG. 12. In this case, two sentences are extracted using the extractor for extracting “complaint about fee”, and three sentences are extracted using the extractor for extracting “complaint about service”. However, despite the inquiries at the call center also including other three sentences indicating claims or demands, there is no extractor for extracting these sentences. As a result, these remaining three sentences are overlooked.

It is therefore desirable to comprehensively and efficiently extract each classified text in the case where various classifications are included in a large amount of text data.

The present invention accordingly has an object of providing a sentence set extraction system, sentence set extraction method, and sentence set extraction program that can comprehensively and efficiently extract each classified sentence even in the case where various classifications are included in a set of sentences to be analyzed.

### Solution to Problem

A sentence set extraction system according to the present invention includes: a similar sentence set generation unit which groups sentences representing a same concept or event from a set of analysis target sentences, to generate a similar sentence set; and a similar sentence set extraction unit which extracts, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

Another sentence set extraction system according to the present invention includes: an analysis sentence set generation unit which generates, using one or more specific sentence extractors each capable of extracting a specific sentence belonging to a specific classification from a set of analysis target sentences, an analysis sentence set obtained by excluding each sentence extracted by any of the specific sentence extractors from the set of analysis target sentences; and a similar sentence set specifying unit which groups sentences representing a same concept or event from the analysis sentence set to generate a similar sentence set, and specifies a similar sentence set including the number of sentences that satisfies a predetermined condition.

A sentence set extraction method according to the present invention includes: grouping sentences representing a same concept or event from a set of analysis target sentences, to generate a similar sentence set; and extracting, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

Another sentence set extraction method according to the present invention includes: generating, using one or more specific sentence extractors each capable of extracting a specific sentence belonging to a specific classification from a set of analysis target sentences, an analysis sentence set obtained by excluding each sentence extracted by any of the specific sentence extractors from the set of analysis target sentences; and grouping sentences representing a same concept or event from the analysis sentence set to generate a similar sentence set, and specifying a similar sentence set including the number of sentences that satisfies a predetermined condition.

A sentence set extraction program according to the present invention causes a computer to execute: a similar sentence set generation process of grouping sentences representing a same concept or event from a set of analysis target sentences, to generate a similar sentence set; and a similar sentence set extraction process of extracting, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

Another sentence set extraction program according to the present invention causes a computer to execute: an analysis sentence set generation process of generating, using one or more specific sentence extractors each capable of extracting a specific sentence belonging to a specific classification from a set of analysis target sentences, an analysis sentence set obtained by excluding each sentence extracted by any of the specific sentence extractors from the set of analysis target sentences; and a similar sentence set specifying process of grouping sentences representing a same concept or event from the analysis sentence set to generate a similar sentence set, and specifying a similar sentence set including the number of sentences that satisfies a predetermined condition.

### ADVANTAGEOUS EFFECTS OF INVENTION

According to the present invention, it is possible to comprehensively and efficiently extract each classified sentence even in the case where various classifications are included in a set of sentences to be analyzed.

### BRIEF DESCRIPTION OF DRAWINGS

FIG. 1 is a block diagram depicting an example of the structure of Exemplary Embodiment 1 of a sentence set extraction system according to the present invention.

FIG. 2 is an explanatory diagram depicting sentence relations.

FIG. 3 is an explanatory diagram depicting an example of a process of generating a similar sentence set.

FIG. 4 is an explanatory diagram depicting an example of displaying the numbers of extracted sentences in table form.

FIG. 5 is a flowchart depicting an example of the operation of the sentence set extraction system in Exemplary Embodiment 1.

FIG. 6 is a block diagram depicting an example of the structure of Exemplary Embodiment 2 of a sentence set extraction system according to the present invention.

FIG. 7 is an explanatory diagram depicting an example of displaying the numbers of sentences included in similar sentence sets in table form.

FIG. 8 is a flowchart depicting an example of the operation of the sentence set extraction system in Exemplary Embodiment 2.

FIG. 9 is a block diagram schematically depicting a sentence set extraction system according to the present invention.

FIG. 10 is a block diagram schematically depicting another sentence set extraction system according to the present invention.

FIG. 11 is a block diagram schematically depicting the structure of a computer.

FIG. 12 is an explanatory diagram depicting an example of a typical method of extracting specific opinions.

### DESCRIPTION OF EMBODIMENT

Exemplary embodiments of the present invention are described below, with reference to drawings.

### Exemplary Embodiment 1

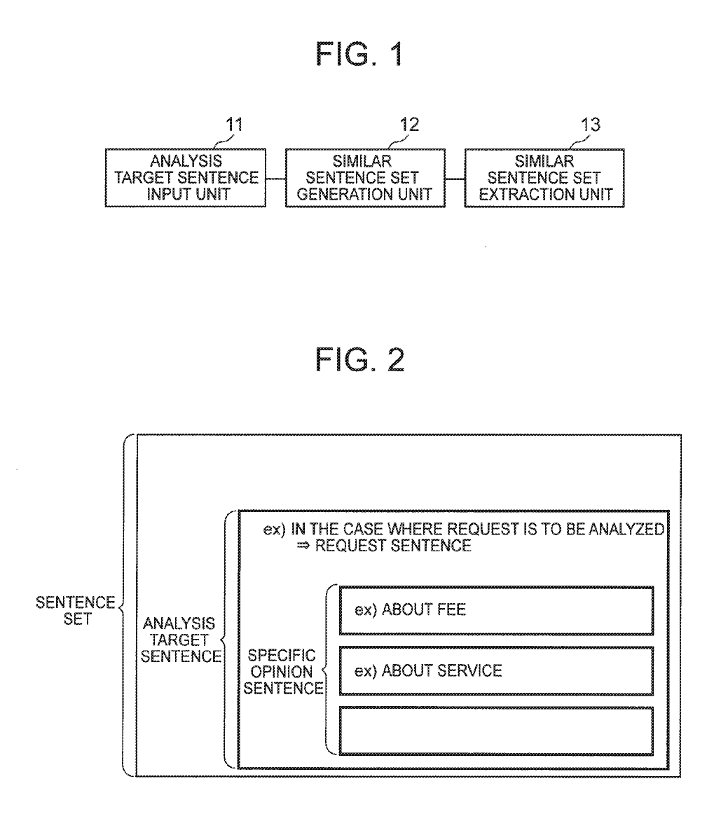

FIG. 1 is a block diagram depicting an example of the structure of Exemplary Embodiment 1 of a sentence set extraction system according to the present invention. The sentence set extraction system in this exemplary embodiment includes an analysis target sentence input unit 11, a similar sentence set generation unit 12, and a similar sentence set extraction unit 13.

The sentence set extraction system in this exemplary embodiment extracts a sentence set for each classification from a set of sentences with contents to be analyzed of a sentence set. In this exemplary embodiment, the term “sentence” is not limited to a unit delimited with a point, a period, or the like, but includes a set of words representing a predetermined meaning.

FIG. 2 is an explanatory diagram depicting sentence relations used in the present invention. As depicted in FIG. 2, a sentence set includes a set of sentences with contents to be analyzed, such as demands or claims. Such sentences are hereafter referred to as “analysis target sentences”. For example, in the case of analyzing a request by a user or the like, the analysis target sentence is a request sentence indicating a request from a user.

As depicted in FIG. 2, each sentence included in the set of analysis target sentences is classified depending on the property of the analysis target sentence. The sentence as a result of classifying the analysis target sentence is hereafter referred to as “specific sentence”. Of analysis target sentences, a sentence as a result of classifying the contents of a demand or a claim can also be referred to as “specific opinion sentence”.

For example, a note or the like created by an operator in a call center is information that can be used to improve a product or a service. The whole sentences included in the note or the like correspond to a sentence set, and each sentence indicating a demand or a claim corresponds to an analysis target sentence. The analysis target sentence classified into any of a plurality of items such as “I prefer lower fee” and “I prefer better service” corresponds to a specific sentence (specific opinion sentence).

The analysis target sentence input unit 11 inputs each analysis target sentence. The analysis target sentence input unit 11 may perform the input by reading the analysis target sentence stored in a storage device (not depicted), or by receiving the analysis target sentence transmitted from another system or device.

In the case where a sentence set at a higher level than the analysis target sentence is input instead of the analysis target sentence, the analysis target sentence input unit 11 may extract the analysis target sentence with contents to be analyzed from the input sentence set. In this case, the analysis target sentence input unit 11 may extract the analysis target sentence using a typically known extractor.

Moreover, for example in the case where a claim or demand input field is included in a screen input by an operator in the call center, the analysis target sentence input unit 11 may input text entered in the input field as the analysis target sentence. The analysis target sentence input unit 11 may perform format conversion and the like on the input analysis target sentence if necessary.

The similar sentence set generation unit 12 groups similar sentences from the analysis target sentence set, to generate a similar sentence set. Any method may be used to generate the similar sentence set. For example, the similar sentence set generation unit 12 may calculate the similarity between sentences in a round-robin system based on the words or syntax included in each sentence, and summarize sentences with high similarity as the similar sentence set. Alternatively, the similar sentence set generation unit 12 may generate the similar sentence set using a typical clustering technique. Each sentence included in the similar sentence set classified in this way corresponds to a specific sentence.

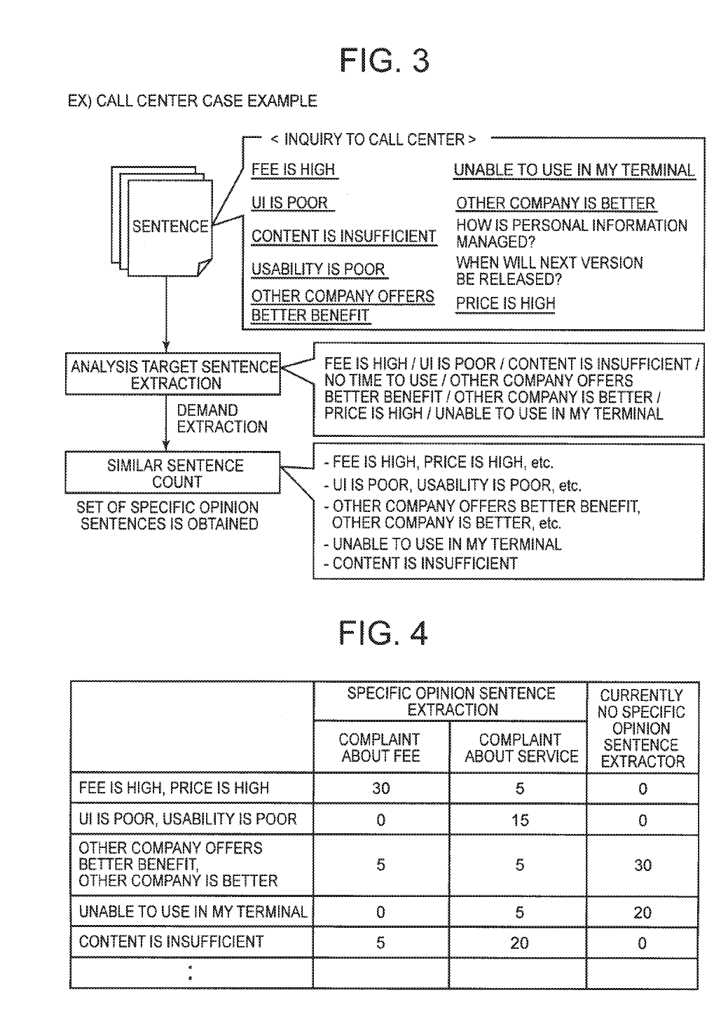

FIG. 3 is an explanatory diagram depicting an example of a process of generating a similar sentence set. In the example depicted in FIG. 3, the analysis target sentence input unit 11 extracts 8 analysis target sentences from 10 pieces of text data indicating inquiries at the call center, by an analysis target sentence extraction process.

Next, the similar sentence set generation unit 12 generates a similar sentence set from the set of analysis target sentences. In the example depicted in FIG. 3, each row in the similar sentence count result corresponds to a similar sentence set. In the example depicted in FIG. 3, the specific sentences “fee is high” and “price is high” indicating the same event belong to the same similar sentence set, and equally the specific sentences “UI is poor” and “usability is poor” belong to the same similar sentence set.

Each similar sentence set obtained by classifying the analysis target sentences desirably has semantic consistency (same concept) so that the classified contents are apparent. Hence, the similar sentence set generation unit 12 desirably generates the similar sentence set by grouping semantically similar sentences from the analysis target sentence set. A known method of grouping semantically similar sentences is clustering based on synonymous or entailment relations. For example, the similar sentence set generation unit 12 may generate the similar sentence set from the analysis target sentence set using the method described in PTL 2. Clustering based on synonymous or entailment relations makes it possible to summarize the contents of the similar sentence set in directly understandable form.

The similar sentence set generation unit 12 may specify a sentence (hereafter referred to as “representative sentence”) indicating the contents of the similar sentence set. As an example, in the case of generating the similar sentence set using an entailment recognition technique, the similar sentence set generation unit 12 may specify text indicating the contents implied by many sentences included in the similar sentence set, as the representative sentence. As another example, in the case of generating the similar sentence set using typical clustering, the similar sentence set generation unit 12 may specify text at the cluster center as the representative sentence.

The similar sentence set extraction unit 13 specifies, using an extractor (hereafter referred to as “specific sentence extractor”) capable of extracting a specific sentence from the analysis target sentence set, a sentence not extracted by the specific sentence extractor from among the sentences belonging to the similar sentence set.

The specific sentence extractor is prepared beforehand depending on the extraction target. The specific sentence extractor may take any form as long as it is capable of extracting a specific sentence indicating desired contents from the analysis target sentence set. For example, the similar sentence set extraction unit 13 may use a specific sentence extractor for extracting text matching a regular expression including a word indicating the desired contents. The method used to extract the specific sentence by the specific sentence extractor is, however, not limited to the use of a regular expression, and a method of extracting the specific sentence based on an extraction rule or an extraction learning model may be used.

In detail, the similar sentence set extraction unit 13 extracts a specific sentence for each similar sentence set, using one or more specific sentence extractors. Here, the similar sentence set extraction unit 13 may count the number of specific sentences extracted from each similar sentence set, for each specific sentence extractor. The similar sentence set extraction unit 13 then specifies each sentence not extracted by the specific sentence extractor, for each similar sentence set. For example, the similar sentence set extraction unit 13 may specify the unextracted sentence by excluding, from the whole similar sentence set, the specific sentences extracted by the specific sentence extractor.

Next, the similar sentence set extraction unit 13 counts the number of unextracted sentences for each similar sentence set. The similar sentence set extraction unit 13 thus extracts one or more sentences not extracted by the specific sentence extractor from among the sentences belonging to the similar sentence set, as a similar sentence set. Here, the similar sentence set extraction unit 13 extracts the similar sentence set depending on the number of specific sentences extracted. In detail, the similar sentence set extraction unit 13 extracts the specified similar sentence set including the number of sentences that satisfies a predetermined condition.

As an example, the similar sentence set extraction unit 13 may extract the similar sentence set with the number of specified sentences that is not less than a predetermined threshold. As another example, the similar sentence set extraction unit 13 may determine a threshold depending on the ratio between “the number of sentences extracted by the specific sentence extractor” and “the number of sentences not extracted by the specific sentence extractor”, and extract the similar sentence set with the number of specified sentences that is not less than the determined threshold. In detail, the threshold is lower when “the number of sentences not extracted by the specific sentence extractor” is greater than “the number of sentences extracted by the specific sentence extractor”.

The classification of the similar sentence set extracted in this way can be regarded as a classification for which there is no extractor for extracting the belonging sentences individually despite the fact that many sentences included in the analysis target sentences belong to the classification. Accordingly, by separately generating an extractor for extracting the sentences belonging to this similar sentence set, each specific sentence can be efficiently extracted from the analysis target sentences and the comprehensiveness of the classifications extracted from the analysis target sentences can be enhanced.

The extracted similar sentence set can be used as learning data for generating an extractor. Thus, in this embodiment, by the similar sentence set extraction unit 13 extracting the similar sentence set, the similar sentence set for which an extractor needs to be generated individually can be specified and also learning data for generating such an extractor can be efficiently collected.

The similar sentence set extraction unit 13 may count the number of sentences extracted using the specific sentence extractor for each similar sentence set, and display the count in table form. FIG. 4 is an explanatory diagram depicting an example of displaying the numbers of extracted sentences in table form. In the table depicted in FIG. 4, the similar sentence sets are shown on the side of the table, and the contents of the specific sentence extractors used for extraction are shown on the top of the table. The rightmost column in the table represents the number of sentences not extracted by any of the specific sentence extractors.

In the example depicted in FIG. 4, as the sentences included in the similar sentence set indicating the contents “fee is high, price is high”, 30 sentences are extracted using a specific sentence extractor for extracting “complaint about fee”, and 5 sentences are extracted using a specific sentence extractor for extracting “complaint about service”. In the example depicted in FIG. 4, there is 0 sentence not extracted by any of the two extractors in the sentences included in the similar sentence set indicating the contents “fee is high, price is high”.

As the sentences included in the similar sentence set indicating the contents “other company offers better benefit, other company is better”, 5 sentences are extracted using the specific sentence extractor for extracting “complaint about fee”, and 5 sentences are extracted using the specific sentence extractor for extracting “complaint about service”. Meanwhile, there are 30 sentences not extracted by any of the two extractors in the sentences included in the similar sentence set indicating the contents “other company offers better benefit, other company is better”.

It is clear from this table that, despite many sentences indicating the contents “other company offers better benefit, other company is better” being included in the analysis target sentences, there is no extractor for appropriately extracting such sentences. Hence, an administrator or the like may generate an extractor for extracting the contents “other company offers better benefit, other company is better” based on this result.

In the example depicted in FIG. 4, for example when the threshold for the number of unextracted sentences is set to 20, the similar sentence set extraction unit 13 can extract two similar sentence sets “other company offers better benefit, other company is better” and “unable to use in my terminal”.

The condition used to extract a similar sentence set by the similar sentence set extraction unit 13 is not limited to the number of sentences included in one similar sentence set. The similar sentence set extraction unit 13 may use the number of sentences included in a new similar sentence set obtained by combining a plurality of specified similar sentence sets, as the condition for extracting a similar sentence set.

In other words, the similar sentence set extraction unit 13 may extract a similar sentence set which is a new similar sentence set including the number of sentences that satisfies a predetermined condition (ratio or number of sentences), the new similar sentence set being obtained by combining (compiling) one or more similar sentence sets each including a sentence not extracted by any specific sentence extractor.

For example, consider the case where, even when the similar sentence set generation unit 12 generates similar sentence sets as separate sets, the administrator wants to generate an extractor capable of extracting the similar sentence sets including similar sentences together upon generating an extractor. Suppose there are the following two similar sentence sets.

Similar sentence set 1 by entailment: “moving image is jumpy, imaging speed of moving image is low”

Similar sentence set 2 by entailment: “standby time is long, I have to wait for screen switching”.

Suppose the similar sentence set generation unit 12 generates these two similar sentence sets separately. Meanwhile, an extractor “request for imaging speed” may be generated as an extractor for extracting sentences included in the two similar sentence sets.

Hence, the similar sentence set generation unit 12 may determine extraction with regard to a new similar sentence set obtained by combining a plurality of similar sentence sets.

Any method may be used to combine a plurality of similar sentence sets. For example, the similar sentence set generation unit 12 may combine a plurality of similar sentence sets designated by the user. Alternatively, the similar sentence set generation unit 12 may combine similar sentence sets determined to be similar, using any method for determining the similarity between similar sentence sets.

Here, the similar sentence set generation unit 12 may extract each similar sentence set depending on the number of sentences included in the similar sentence set or the ratio between the sentences extracted by the specific sentence extractor and the sentences not extracted by the specific sentence extractor, as in the aforementioned method. Instead of directly using the number of sentences included in each of the similar sentence sets combined, the similar sentence set generation unit 12 may compare a value calculated depending on the similarity of the combined similar sentence sets with a threshold. For example, the similar sentence set generation unit 12 may add or multiply the respective numbers of sentences included in the combined two similar sentence sets and further multiply the result by the similarity and, in the case where the result exceeds a predetermined threshold, extract a new similar sentence set obtained by combining them.

The analysis target sentence input unit 11, the similar sentence set generation unit 12, and the similar sentence set extraction unit 13 are realized by a CPU of a computer operating according to a program (sentence set extraction program). For example, the program may be stored in a storage unit (not depicted) included in an information processing device for realizing the sentence set extraction system, with the CPU reading the program and operating as the analysis target sentence input unit 11, the similar sentence set generation unit 12, and the similar sentence set extraction unit 13 according to the program. Alternatively, the analysis target sentence input unit 11, the similar sentence set generation unit 12, and the similar sentence set extraction unit 13 may each be realized by dedicated hardware.

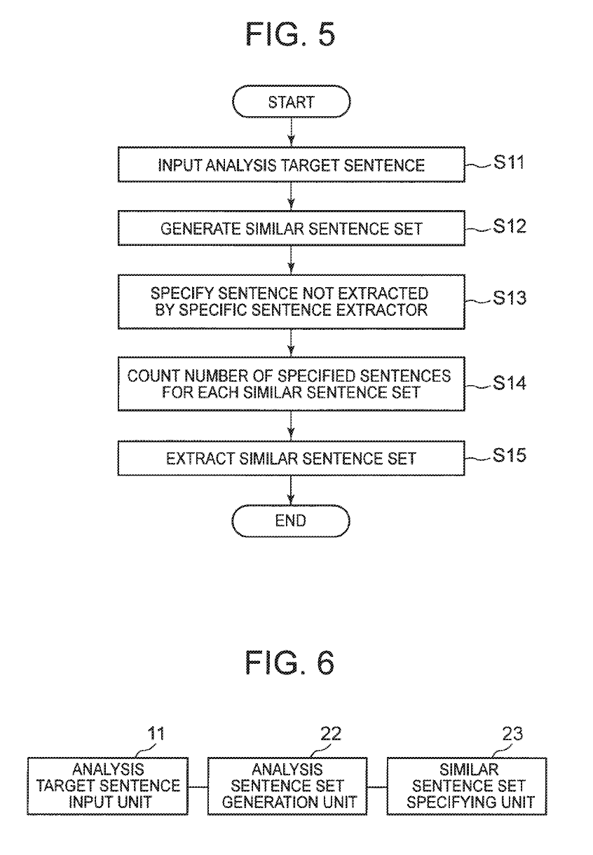

The following describes the operation of the sentence set extraction system in this exemplary embodiment. FIG. 5 is a flowchart depicting an example of the operation of the sentence set extraction system in this exemplary embodiment.

The analysis target sentence input unit 11 inputs each analysis target sentence (step S11). The similar sentence set generation unit 12 groups semantically similar sentences from the input analysis target sentence set, to generate a similar sentence set (step S12). The similar sentence set extraction unit 13 specifies a sentence not extracted by any specific sentence extractor from among the sentences belonging to the similar sentence set (step S13), and counts the number of specified sentences for each similar sentence set (step S14). The similar sentence set extraction unit 13 extracts a similar sentence set including the number of specified sentences that satisfies a predetermined condition (step S15).

As described above, in this exemplary embodiment, the similar sentence set generation unit 12 groups similar sentences from an analysis target sentence set to generate a similar sentence set, and the similar sentence set extraction unit 13 extracts, using one or more specific sentence extractors, one or more sentences not extracted by any specific sentence extractor from among the sentences belonging to the similar sentence set, as a similar sentence set.

With such a structure, a similar sentence set for which an extractor is to be generated can be specified. It is therefore possible to comprehensively and efficiently extract each classified sentence even in the case where various classifications are included in a set of sentences to be analyzed.

### Exemplary Embodiment 2

FIG. 6 is a block diagram depicting an example of the structure of Exemplary Embodiment 2 of a sentence set extraction system according to the present invention. The same components as those in Exemplary Embodiment 1 are given the same reference signs as in FIG. 1, and their description is omitted. The sentence set extraction system in this exemplary embodiment includes the analysis target sentence input unit 11, an analysis sentence set generation unit 22, and a similar sentence set specifying unit 23.

Thus, the sentence set extraction system in this exemplary embodiment includes the analysis sentence set generation unit 22 and the similar sentence set specifying unit 23, instead of the similar sentence set generation unit 12 and the similar sentence set extraction unit 13 in Exemplary Embodiment 1.

The analysis sentence set generation unit 22 generates a set (hereafter referred to as “analysis sentence set”) obtained by excluding, from an analysis target sentence set, each sentence extracted by any specific sentence extractor. The specific sentence extractor used in analysis sentence set generation unit 22 is the same as the specific sentence extractor used in the similar sentence set extraction unit 13 in Exemplary Embodiment 1.

In detail, the analysis sentence set generation unit 22 extracts each specific sentence from the analysis target sentences using one or more specific sentence extractors, and excludes the extracted specific sentences from the analysis target sentences to generate an analysis sentence set.

The similar sentence set specifying unit 23 groups similar sentences from the generated analysis sentence set, to generate a similar sentence set. The method of generating a similar sentence set is the same as the method of generating a similar sentence set by the similar sentence set generation unit 12 in Exemplary Embodiment 1. The similar sentence set specifying unit 23 then counts the number of sentences included in each similar sentence set, and specifies a similar sentence set including the number of sentences that satisfies a predetermined condition. In detail, the similar sentence set specifying unit 23 may specify a similar sentence set including the number of sentences that is not less than a predetermined threshold, or specify a similar sentence set by comparing the ratio used by the similar sentence set extraction unit 13 in Exemplary Embodiment 1 with a threshold.

The classification of such a specified similar sentence set can be regarded as a classification for which there is no extractor for extracting the belonging sentences individually despite the fact that many sentences included in the analysis target sentences belong to the classification, as in Exemplary Embodiment 1. Accordingly, by separately generating an extractor for extracting the sentences belonging to this similar sentence set, each specific sentence can be efficiently extracted from the analysis target sentences and the comprehensiveness of the classifications extracted from the analysis target sentences can be enhanced.

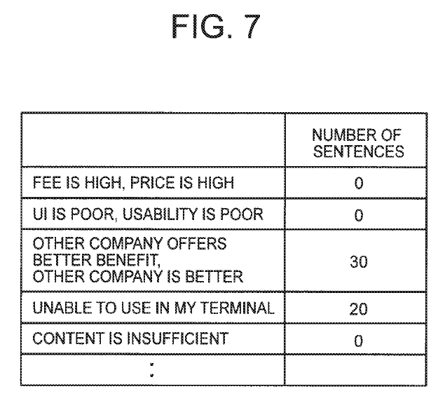

The similar sentence set specifying unit 23 may display the number of sentences included in each similar sentence set in table form. FIG. 7 is an explanatory diagram depicting an example of displaying the numbers of sentences included in extracted similar sentence sets in table form. The number of sentences included in each similar sentence set in FIG. 7 corresponds to the number of sentences not extracted by any specific sentence extractor in FIG. 4.

The analysis target sentence input unit 11, the analysis sentence set generation unit 22, and the similar sentence set specifying unit 23 are realized by a CPU of a computer operating according to a program (sentence set extraction program). Alternatively, the analysis target sentence input unit 11, the analysis sentence set generation unit 22, and the similar sentence set specifying unit 23 may each be realized by dedicated hardware.

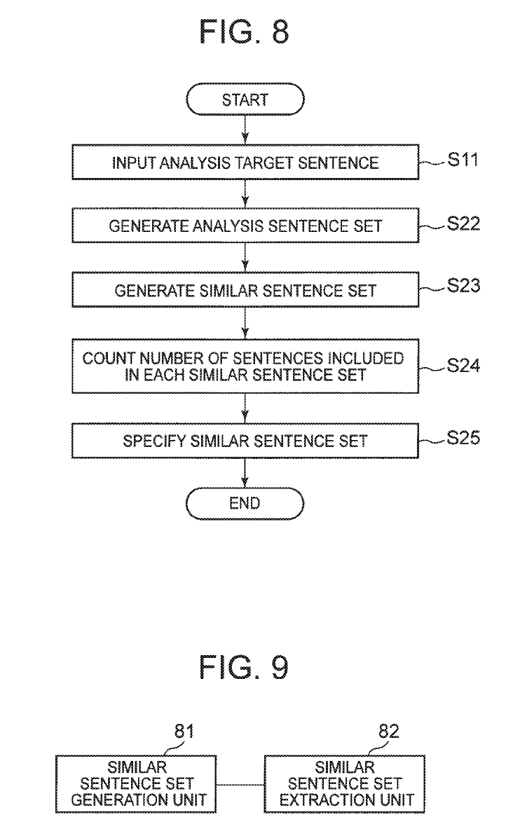

The following describes the operation of the sentence set extraction system in this exemplary embodiment. FIG. 8 is a flowchart depicting an example of the operation of the sentence set extraction system in this exemplary embodiment.

The analysis target sentence input unit 11 inputs each analysis target sentence (step S11). The analysis sentence set generation unit 22 generates an analysis sentence set by excluding each sentence extracted by any specific sentence extractor from the analysis target sentence set (step S22). The similar sentence set specifying unit 23 groups semantically similar sentences from the analysis sentence set, to generate a similar sentence set (step S23). The similar sentence set specifying unit 23 counts the number of sentences included in each similar sentence set (step S24), and specifies a similar sentence set including the number of sentences that satisfies a predetermined condition (step S25).

As described above, in this exemplary embodiment, the analysis sentence set generation unit 22 generates an analysis sentence set by excluding sentences extracted by one or more specific sentence extractors from an analysis target sentence set, and the similar sentence set specifying unit 23 groups similar sentences from the analysis sentence set to generate a similar sentence set. The similar sentence set specifying unit 23 then specifies a similar sentence set including the number of sentences that satisfies a predetermined condition.

With such a structure, too, a similar sentence set for which an extractor is to be generated can be specified, as in Exemplary Embodiment 1. It is therefore possible to comprehensively and efficiently extract each classified sentence even in the case where various classifications are included in a set of sentences to be analyzed.

In the sentence set extraction system in Exemplary Embodiment 2, the sentences extracted by each specific sentence extractor are excluded before generating a similar sentence set. This can reduce the number of sentences subjected to the similar sentence set generation, and accordingly shorten processing time as compared with the sentence set extraction system in Exemplary Embodiment 1.

In the sentence set extraction system in Exemplary Embodiment 1, on the other hand, the sentences extracted by each specific sentence extractor are specified before excluding the sentences extracted by the specific sentence extractor. Thus, the respective numbers of sentences extracted by a plurality of specific sentence extractors can also be specified, as compared with the sentence set extraction system in Exemplary Embodiment 2.

The following describes an overview of the present invention. FIG. 9 is a block diagram schematically depicting a sentence set extraction system according to the present invention. The sentence set extraction system according to the present invention includes: a similar sentence set generation unit 81 (e.g. the similar sentence set generation unit 12) which groups sentences representing a same concept or event from a set of analysis target sentences, to generate a similar sentence set (e.g. a specific sentence set); and a similar sentence set extraction unit 82 (e.g. the similar sentence set extraction unit 13) which extracts, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

With such a structure, it is possible to comprehensively and efficiently extract each classified sentence even in the case where various classifications are included in a set of sentences to be analyzed.

In detail, the similar sentence set extraction unit 82 may extract a similar sentence set which is a new similar sentence set including the number of sentences that satisfies a predetermined condition (e.g. the number of sentences, ratio, or the like is not less than a predetermined threshold), the new similar sentence set being obtained by compiling one or more similar sentence sets each including a sentence not extracted by any of the specific sentence extractors. The similar sentence set extraction unit 82 may specify each similar sentence set including a sentence not extracted by any of the specific sentence extractors, and extract a similar sentence set which is a specified similar sentence set including the number of sentences that satisfies a predetermined condition.

The similar sentence set generation unit 81 may generate the similar sentence set by clustering of the set of analysis target sentences based on a synonymous or entailment relation between analysis target sentences. With such a structure, the contents of the similar sentence set can be summarized in directly understandable form. Hence, contents extracted by an extractor to be newly generated can be classified so as to be easily understandable.

The similar sentence set extraction unit 82 may count, for each similar sentence set, the number of sentences extracted by each of the specific sentence extractors, and output, for each similar sentence set, the number of sentences extracted by each of the specific sentence extractors and the number of sentences not extracted by any of the specific sentence extractors. This eases the recognition of the extraction state of each currently used specific sentence extractor and any similar sentence set for which a specific sentence extractor needs to be newly generated.

The sentence set extraction system may include an analysis target sentence input unit (e.g. the analysis target sentence input unit 11) which extracts the analysis target sentences from an input sentence set. With such a structure, information other than sentences subjected to extractor generation can be excluded beforehand, with it being possible to generate an accurate specific sentence extractor.

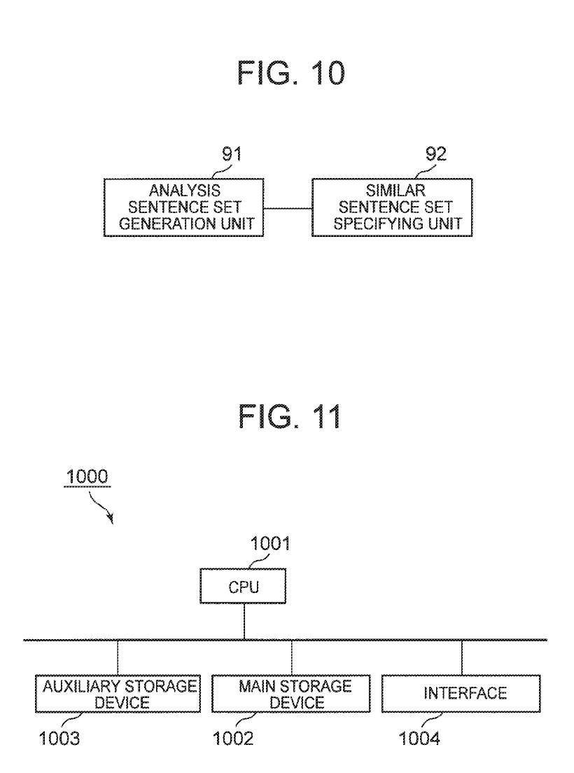

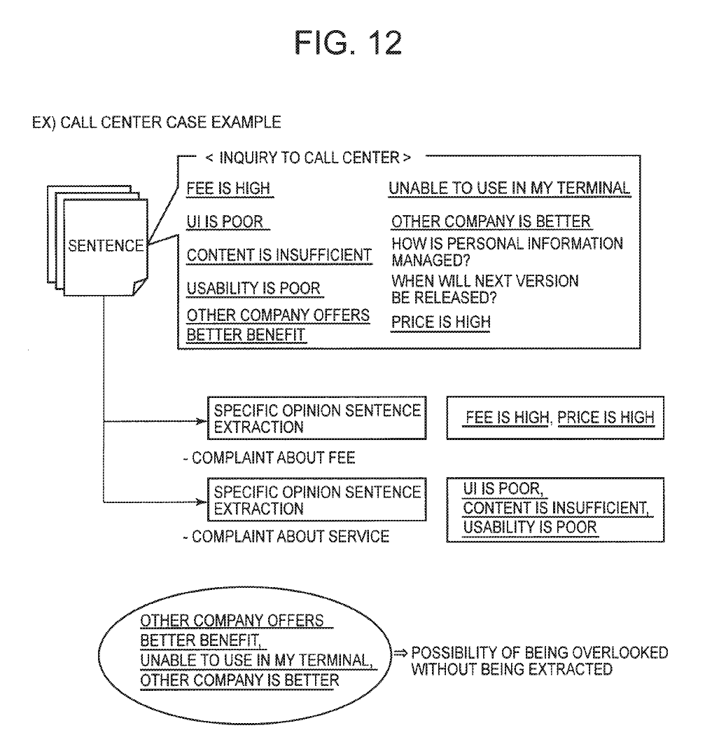

FIG. 10 is a block diagram schematically depicting another sentence set extraction system according to the present invention. Another sentence set extraction system according to the present invention includes: an analysis sentence set generation unit 91 (e.g. the analysis sentence set generation unit 22) for generating, using one or more specific sentence extractors each capable of extracting a specific sentence belonging to a specific classification from a set of analysis target sentences, an analysis sentence set obtained by excluding each sentence extracted by any of the specific sentence extractors from the set of analysis target sentences; and a similar sentence set specifying unit 92 (e.g. the similar sentence set specifying unit 23) for grouping sentences representing a same concept or event from the analysis sentence set to generate a similar sentence set, and specifying a similar sentence set including the number of sentences that satisfies a predetermined condition (e.g. being not less than a predetermined threshold).

With such a structure, too, it is possible to comprehensively and efficiently extract each classified sentence even in the case where various classifications are included in a set of sentences to be analyzed.

The similar sentence set specifying unit 92 may generate the similar sentence set by clustering of the analysis sentence set based on a synonymous or entailment relation between analysis target sentences. With such a structure, too, the contents of the similar sentence set can be summarized in directly understandable form. Hence, contents extracted by an extractor to be newly generated can be classified so as to be easily understandable.

FIG. 11 is a block diagram schematically depicting the structure of a computer. A computer 1000 includes a CPU 1001, a main storage device 1002, an auxiliary storage device 1003, and an interface 1004.

The aforementioned sentence set extraction system is implemented in at least one computer 1000. The sentence set extraction system according to the present invention may be realized as one device, or two or more physical separate devices connected wiredly or wirelessly.

The operation of each processing unit described above is stored in the auxiliary storage device 1003 in the form of a program (sentence set extraction program). The CPU 1001 reads the program from the auxiliary storage device 1003 and expands the program in the main storage device 1002, and executes the process according to the program.

In at least one exemplary embodiment, the auxiliary storage device 1003 is an example of a non-transitory tangible medium. Other examples of the non-transitory tangible medium include a magnetic disk, magneto-optical disk, CD-ROM (Compact Disc Read Only Memory), DVD-ROM (Digital Versatile Disk Read Only Memory), semiconductor memory, etc. connected via the interface 1004. In the case where the program is distributed to the computer 1000 through a communication line, the computer 1000 to which the program has been distributed expands the program in the main storage device 1002 and executes the process.

The program may realize part of the functions described above. The program may be a difference file (difference program) for realizing the functions described above when combined with another program already stored in the auxiliary storage device 1003.

Although the present invention has been described with reference to the exemplary embodiments and examples, the present invention is not limited to the exemplary embodiments and examples. Various changes understandable by those skilled in the art can be made to the structures and details of the present invention within the scope of the present invention.

This application claims priority based on Japanese Patent Application No. 2014-149425 filed on Jul. 23, 2014, the disclosure of which is incorporated herein in its entirety.

### REFERENCE SIGNS LIST

11 analysis target sentence input unit

12 similar sentence set generation unit

13 similar sentence set extraction unit

22 analysis sentence set generation unit

23 similar sentence set specifying unit

1. A sentence set extraction system comprising:
a hardware including a processor;
a similar sentence set generation unit, implemented by the processor, which groups sentences representing a same concept or event from a set of analysis target sentences, to generate a similar sentence set; and
a similar sentence set extraction unit, implemented by the processor, which extracts, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

2. The sentence set extraction system according to claim 1, wherein the similar sentence set extraction unit extracts a similar sentence set which is a new similar sentence set including the number of sentences that satisfies a predetermined condition, the new similar sentence set being obtained by compiling one or more similar sentence sets each including a sentence not extracted by any of the specific sentence extractors.

3. The sentence set extraction system according to claim 1, wherein the similar sentence set extraction unit specifies each similar sentence set including a sentence not extracted by any of the specific sentence extractors, and extracts a similar sentence set which is a specified similar sentence set including the number of sentences that satisfies a predetermined condition.

4. The sentence set extraction system according to claim 1, wherein the similar sentence set generation unit generates the similar sentence set by clustering of the set of analysis target sentences based on a synonymous or entailment relation between analysis target sentences.

5. The sentence set extraction system according to claim 1, wherein the similar sentence set extraction unit counts, for each similar sentence set, the number of sentences extracted by each of the specific sentence extractors, and outputs, for each similar sentence set, the number of sentences extracted by each of the specific sentence extractors and the number of sentences not extracted by any of the specific sentence extractors.

6. The sentence set extraction system according to claim 1, comprising
an analysis target sentence input unit, implemented by the processor, which extracts the analysis target sentences from an input sentence set.

7. A sentence set extraction system comprising:
a hardware including a processor;
an analysis sentence set generation unit, implemented by the processor, which generates, using one or more specific sentence extractors each capable of extracting a specific sentence belonging to a specific classification from a set of analysis target sentences, an analysis sentence set obtained by excluding each sentence extracted by any of the specific sentence extractors from the set of analysis target sentences; and
a similar sentence set specifying unit, implemented by the processor, which groups sentences representing a same concept or event from the analysis sentence set to generate a similar sentence set, and specifies a similar sentence set including the number of sentences that satisfies a predetermined condition.

8. The sentence set extraction system according to claim 7, wherein the similar sentence set specifying unit generates the similar sentence set by clustering of the analysis sentence set based on a synonymous or entailment relation between analysis target sentences.

9. A sentence set extraction method comprising:
grouping sentences representing a same concept or event from a set of analysis target sentences, to generate a similar sentence set; and
extracting, using one or more specific sentence extractors each capable of extracting a specific sentence belonging to a specific classification from the set of analysis target sentences, one or more sentences not extracted by any of the specific sentence extractors from among the sentences belonging to the similar sentence set, as an exclusion similar sentence set.

10. The sentence set extraction method according to claim 9, wherein a similar sentence set which is a new similar sentence set including the number of sentences that satisfies a predetermined condition is extracted, the new similar sentence set being obtained by compiling one or more similar sentence sets each including a sentence not extracted by any of the specific sentence extractors.

11.-16. (canceled)
